(19) United States
(12) Patent Application Publication
(10) Pub. No.: US 2014/0137420 A1
(43) Pub. Date: May 22, 2014

(54) Castable Depth Finding Device

(71) Applicant: Gregory Vernon Seefeldt, Jenks, OK (US)

(72) Inventor: Gregory Vernon Seefeldt, Jenks, OK (US)

(21) Appl. No.: 14/083,083

(22) Filed: Nov. 18, 2013

Related U.S. Application Data
(60) Provisional application No. 61/728,823, filed on Nov. 21, 2012.

(51) Int. Cl. A01K 91/20

(52) U.S. Cl. CPC A01K 91/20
USPC 33/719

(57) ABSTRACT

The embodiments of the Castable Depth Finding Device are comprised of a lower body, a lower cavity, an upper body, an upper cavity, a hollow tube, an arch, a fishing line hole, a body neck, a water emptying port, a calibrated scale, a weight, a left lower member, a right lower member, a platform, and a pin. The lower body is constructed of a transparent material so internal contents can be viewed. The lower cavity is formed by the lower body and is located inside of lower body. The upper body forms the upper cavity and is located inside of upper body. Upper cavity is open to lower cavity. The castable depth finding device can be tied onto a fishing line or a string. It can also be clipped onto a line or onto a fishing lure with a clip or a swivel.

### CROSS-REFERENCE TO RELATED APPLICATIONS

This application is a non-provisional patent application of pending U.S. provisional patent application with Ser. No. 61/728,823 titled “Castable Depth Finding Device” filed on Nov. 21, 2012. This application claims priority of U.S. provisional patent application with Ser. No. 61/728,823 the entire contents of U.S. provisional patent application with Ser. No. 61/728,823, U.S. are herein incorporated by reference.

### STATEMENT REGARDING FEDERALLY SPONSORED RESEARCH OR DEVELOPMENT

Not applicable

### FIELD OF THE EMBODIMENTS

The field of the embodiments of the Castable Depth Finding Device is liquid level meters. One application of the embodiments is the determination of the depth of a body of water for fishing.

### BACKGROUND OF THE EMBODIMENTS

The background of the embodiments includes the general area of fishing accessories. More specifically, but in no manner intended to limit the scope of the invention, the background includes while fishing in a body of water such as a pond, lake, stream, or river, it is often useful to know the water depths in different areas of the body of water. Varying species of fish will typically inhabit specific water depths in a particular body of water at certain times of the day and certain times of the year. Also, some species of fish tend to prefer staying near certain underwater structure such as drop-offs, shallow flats, or creek channels. Understanding the approximate depth in various parts of a body of water can help a fisherman to target the preferred species of fish they are trying to catch. For example, during the hot part of the summer bass will often be found in the deepest part of a small pond. In the spring, the bass will often be found in the shallower areas of the same small pond.

### SUMMARY OF THE EMBODIMENTS

In summary, the embodiments of the Castable Depth Finding Device are comprised of a lower body, a lower cavity, an upper body, an upper cavity, a hollow tube, an arch, a fishing line hole formed by the arch, a body neck, a water emptying port, a calibrated scale, a weight, a left lower member, a right lower member, a platform, and a pin.

The lower body is constructed of a transparent material so internal contents can be viewed. The lower cavity is formed by the lower body and is located inside of lower body. The upper body forms the upper cavity and is located inside of upper body. The upper cavity is hydraulically connected to the lower cavity.

In this respect, it is to be understood that the embodiments in this application are not limited to the details of construction and to the arrangements of the components set forth in the description or illustrated in the drawings. The embodiments are capable of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the embodiments described in this application. Additional benefits and advantages of the present embodiments will become apparent in those skilled in the art to which the embodiments relate from the description of the preferred embodiment and the appended claims, taken in conjunction with the accompanying drawings. It is important, therefore, that the claims be regarded as including such equivalent constructions insofar as they do not depart from the spirit and scope of the embodiments described herein.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the embodiments of the application, which is measured by the claims, nor is it intended to be limiting as to the scope of the embodiments in any way.

### BRIEF DESCRIPTION OF THE DRAWINGS

FIG. 1 is a perspective view of an embodiment of the castable depth finding device.

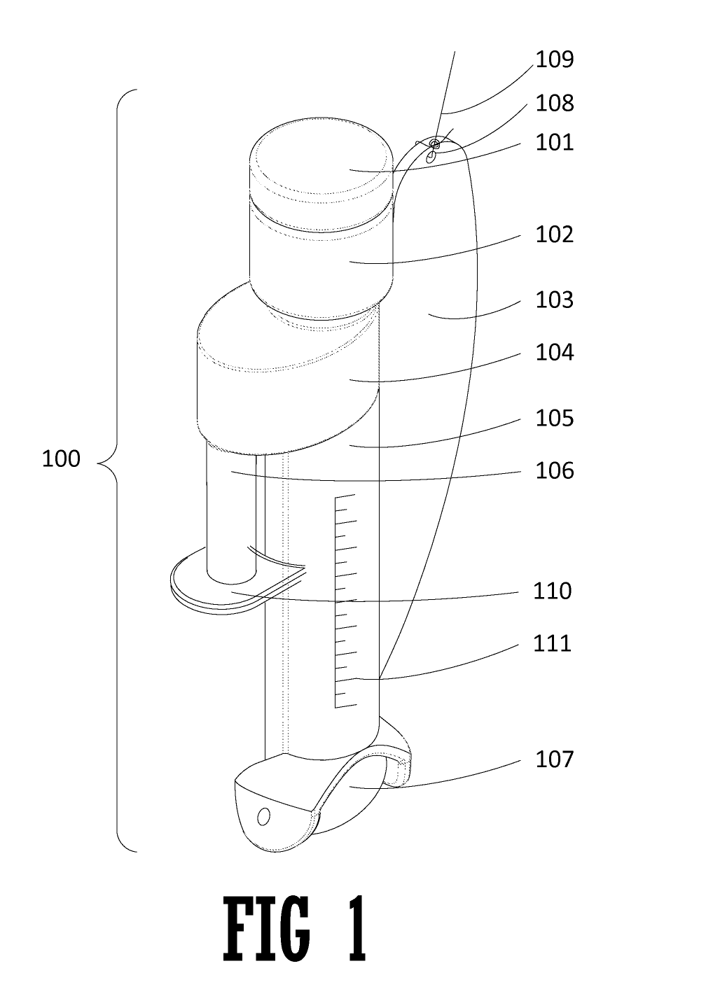

FIG. 2 is a side, exploded view of the castable depth finding device.

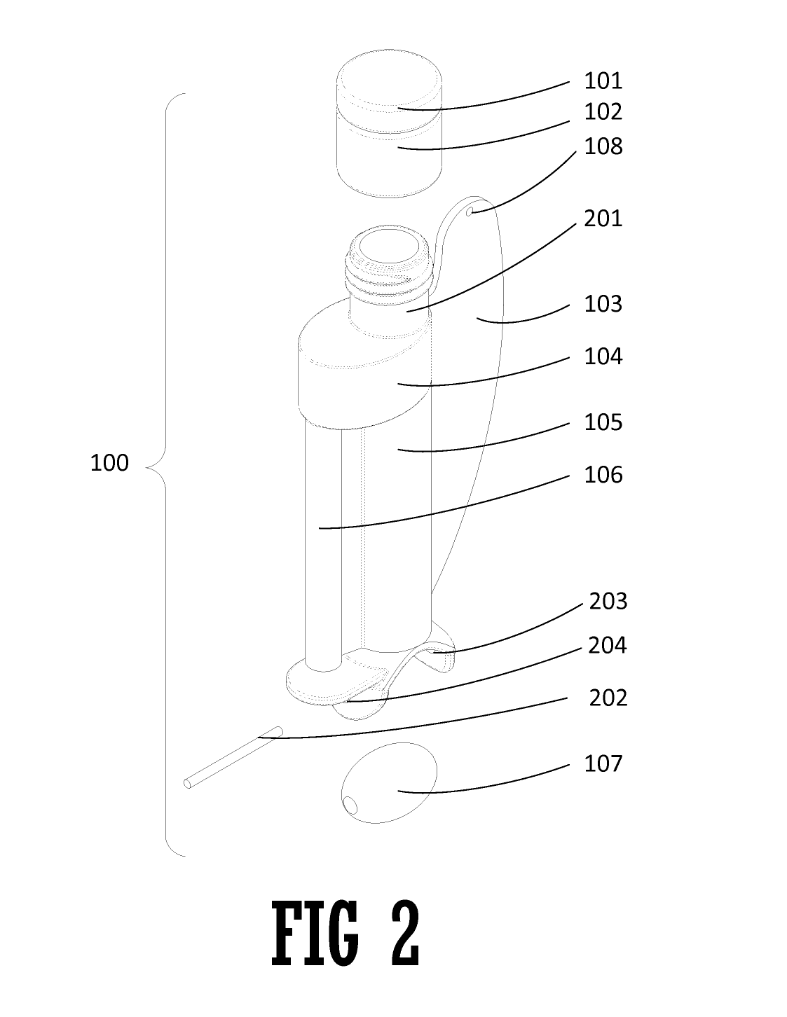

FIG. 3A is a side view of an embodiment of the castable depth finding device. FIG. 3B is a cross section of an embodiment of the castable depth finding device showing the internal cavities.

### DETAILED DESCRIPTION OF THE PREFERRED EMBODIMENTS

Embodiments of the Castable Depth Finding Device 100 are comprised of a lower body 105, a lower cavity 302, a upper body 104, a upper cavity 301, a hollow tube 106, an arch 103, a fishing line hole 108 formed by the arch, a body neck 201, a water emptying port 102, a calibrated scale 111, a weight 107, a left lower member 204, a right lower member 203, a platform 110, and a pin 202.

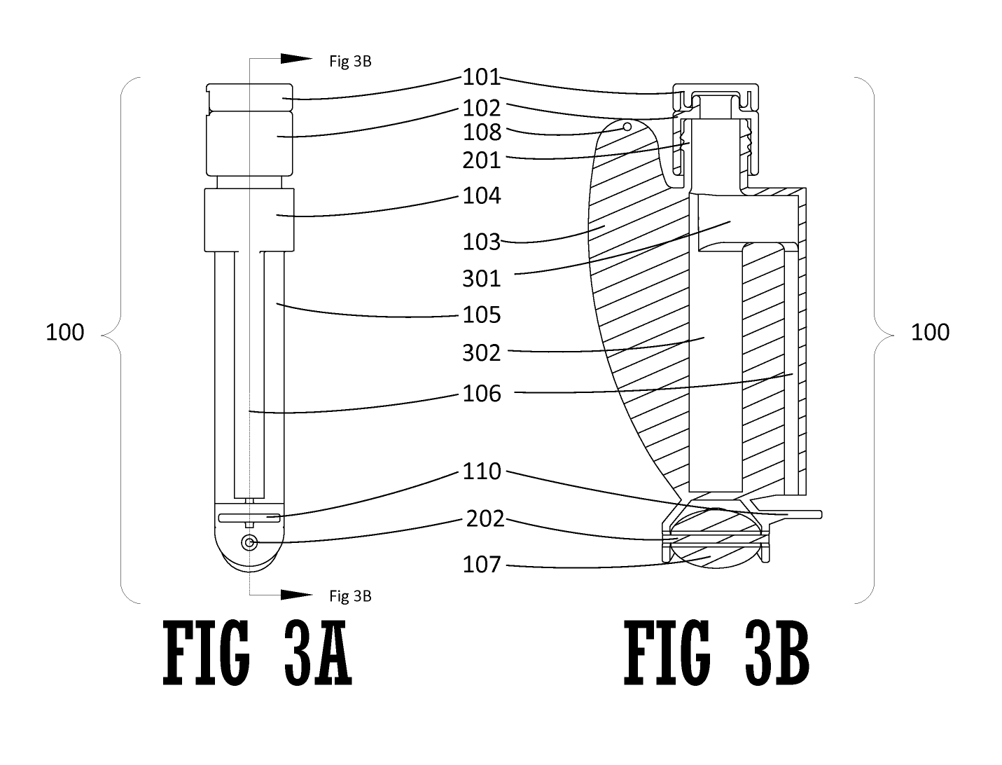

The lower body 105 is constructed of a transparent polymeric material so internal contents can be viewed. The lower cavity 302 is formed by the lower body 105 and is located inside of lower body 105. The lower cavity 302 is shown FIG. 3 and in cross section. The upper body 104 forms the upper cavity 301 and is located inside of upper body 104. The upper cavity 301 is hydraulically connected to the lower cavity 302. FIG. 3 shows upper cavity 301 in a cross section view.

The hollow tube 106 extends downward from the upper body 104. The upper end of hollow tube 106 is hydraulically connected to upper cavity 301. The lower end of hollow tube 106 is hydraulically connected to the surrounding environment as shown in FIG. 3.

The arch 103 is adjacent to the lower body 105 and upper body 104. The arch 103 forms a fishing line hole 108 in the arch 103. In an embodiment of the Castable Depth Finding Device, the fishing line hole 108 allows the castable depth finding device to be cast or lowered into the water and retrieved via a fishing line 109.

The body neck 201 is hollow in the inside with an opening at the top. The bottom portion of the body neck 201 is hydraulically connected to upper cavity 301. See FIG. 3B. The water emptying port 102 fastens to the body neck 201. In one embodiment, the fastening means is a threaded connection so that the emptying port 102 threadedly connects to the body neck 201. The water emptying port 102 comprises a water emptying means 101 that is opened to empty the contents of the Castable Depth Finding Device 100. The water emptying means 101 includes without limitation a flip-top cap, a screw top (that you remove to empty), a tulip style dispensing cap, or a disk style dispensing cap.

The calibrated scale 111 is located on the outside lower body 105. The weight 107 mounts below lower body 105 between the lower members 203 and 204. The left lower member 204 and the right lower member 203 are lower members that extend from the bottom of lower body 105. Lower members 203 and 204 provide a mounting location for the weight 107. A platform 110 extends in a perpendicular direction from the side of lower body 105. The platform 110 extends out past the bottom of the hollow tube 106. The pin 202 affixes the weight 107 to the lower members 203 and 204.

In the best mode of operation of the embodiments of the Castable Depth Finding Device 100, one of the embodiments is affixed to fishing line 109 via the fishing line hole 108. The water emptying port 102 is closed to prevent water from entering through the body neck 201 and to prevent air from leaking out of the body neck 201. The water emptying port is closed by affixing the water emptying port 102 to the body neck 201 via the threaded connection and closing the flip-top cap. The castable depth finding device is cast or lowered into the water. The weight 107 provides additional mass to allow the castable depth finding device to be cast further distances and to sink to the bottom of the body of water. The platform 110 helps reduce water from being forced up hollow tube 106 as a result of the castable depth finding device splashing into the water. Minimizing the amount of water that enters into the upper cavity 301 or the lower cavity 302 when the device splashes into the water, before the castable depth finding devices begins to sink, helps to provide the most accurate results. The weight 107 on the bottom of the castable depth finding device helps it to sink in the upright position (upper body 104 at the top and weight 107 at the bottom), which helps provide the most accurate results.

As the castable depth finding device descends deeper in the water, the external water pressure increases. The pressure in the water increases linearly with depth at a rate of approximately 1 psi for every additional 2.31 feet of depth. At the beginning of its descent in the water, the castable depth finding device contains air at ambient pressure (the pressure of the air at the surface) inside of lower cavity 302, upper cavity 301, hollow tube 106 and body neck 201.

These internal cavities are connected to the outside atmosphere (air or water) via the hollow tube 106 extending from the bottom of upper body 104. As the external water pressure increases, water enters through hollow tube 106, passes through upper cavity 301, and begins to fill lower cavity 302. The water fills lower cavity 302 and compresses the air inside of the lower cavity 302, the upper cavity 301, the hollow tube 106 and the body neck 201 until it equalizes with the external water pressure.

During the descent water enters through hollow tube 106 to equalize the pressure and no air escapes out of hollow tube 106. During descent no air escapes the cavities. When the castable depth finding device sinks to the bottom of the body of water, it comes to a rest and remains in the upright position, due to the location of weight 107 on the bottom and the buoyancy of the air in lower cavity 302, upper cavity 301, hollow tube 106 and body neck 201. The downward orientation of the hollow tube 106 prevents air from escaping after the pressure has been equalized, even though the internal air is more buoyant than the water.

After reaching the bottom, the castable depth finding device is retrieved, and it begins to ascend back up through the water. As the castable depth finding device moves through the water, the arch 103 helps it to slide over structure such as tree branches, rocks, or weeds and to reduce the likelihood of snagging the castable depth finding device. As the castable depth finding device rises through the water into shallower depths, the external water pressure decreases. Air bubbles begin escaping through hollow tube 106 to constantly equalize the pressure in lower cavity 302, upper cavity 301, hollow tube 106 and body neck 201 as the castable depth finding device ascends. When the Castable Depth Finding Device ascends the surface the air escapes to equalize the pressure, but the water remains in the lower chamber. The volume of air at ambient pressure that escapes will be approximately equal to the volume of water that entered the castable depth finding device on the descent. The water that entered the lower cavity 302, upper cavity 301, hollow tube 106 and body neck 201 is held in lower cavity 302 during the ascent. During the ascent, air exits but no water exits.

After the castable depth finding device is brought to the surface of the water, the height of water contained in lower cavity 302 can be viewed, since the lower body 105 is constructed of a transparent material. This height is compared to calibrated scale 111 on the castable depth finding device, which includes marks that correspond to different depths of water. This allows the user to determine what maximum depth of water the castable depth finding device reached.

The water emptying port 102 is opened and the castable depth finding device is inverted to remove the water from it. The castable depth finding device is ready to be used again starting with the procedure described above.

In other embodiments of the Castable Depth Finding Device 100, the hollow tube 106 extends up into the upper cavity 301. Various materials of construction, such as different polymeric materials, can be used for all materials. In addition, this description is not meant to be limiting in regards to the sizes, and interconnections can be used for all elements.

In other embodiments of the Castable Depth Finding Device 100, The lower body 105, upper body 104, hollow tube 106, arch 103, body neck 201, water emptying port 102, calibrated scale 111, lower members 204/R, platform 110 can be manufactured as separate components and assembled together or they can be manufactured in variety of combined combinations, or even as a single piece. The weight 107 can be connected in various means.

In other embodiments of the Castable Depth Finding Device 100, the hollow tube 106 can include a 90 to 180 degree bend at the bottom of the hollow tube. This bend can be used in conjunction with or in place of the platform 110 to help reduce water from being forced up hollow tube 106 as a result of the castable depth finding device splashing into the water.

The castable depth finding device can be tied onto a fishing line or a string. It can also be clipped onto a line or onto a fishing lure with a clip or a swivel. A different calibrated scale 111 can be provided for saltwater and freshwater applications. A different calibrated scale can be provided for depth in feet or meters. A different calibrated scale can be used for bodies of water at different location altitudes. The same castable depth finding device can include single or multiple scales.

In other embodiments of the Castable Depth Finding Device 100, the shape of the arch 103 can be modified. The water emptying port 102 can be provided in a variety of shapes, designs, or sizes. It can be a separate device that mounts to the body neck 201, or it can be built into the upper body 104 or any other component that has an internal cavity. The body neck 201 could also be eliminated in some case. The shape of the lower body 105, upper body 104, or hollow tube can be round, oval, rectangular, triangular or a variety of other shapes.

I claim:

1. A castable depth finding device comprised of
a. a lower body,
b. a lower cavity,
c. an upper body,
d. an upper cavity,
e. a hollow tube,
f. a water emptying port,
g. a calibrated scale, and
h. a weight.

2. The castable depth finding device described in claim 1 wherein
a. the lower body is constructed of a transparent polymeric material,
b. the lower cavity is formed by the lower body and is located inside of the lower body,
c. the upper body forms the upper cavity and is located inside of the upper body, and
d. the upper cavity is hydraulically connected to the lower cavity.

3. The castable depth finding device described in claim 1 wherein
a. the hollow tube extends downward from the upper body,
b. an upper end of hollow tube is hydraulically connected to the upper cavity,
c. an lower end of hollow tube is open to surrounding environment,
d. an arch is adjacent to the lower body and upper body, and
e. the arch forms a fishing line hole in the arch.

4. The castable depth finding device described in claim 1 wherein a fishing line hole allows the castable depth finding device to be cast or lowered into the water and retrieved via a fishing line.

5. The castable depth finding device described in claim 1 wherein
a. a body neck that is hollow in the inside with an opening at the top,
b. a bottom portion of the body neck is hydraulically connected to the upper cavity, and
c. a water emptying port that threadedly connects to the body neck.

6. The castable depth finding device described in claim 1 comprising a water emptying port that comprises a water emptying means that can be opened to empty the contents of the castable depth finding device.

7. The castable depth finding device described in claim 6 wherein the water emptying means is a flip-top cap, a screw top, a tulip style dispensing cap, or a disk style dispensing cap.

8. The castable depth finding device described in claim 1 wherein
a. the calibrated scale is located on the outside of the lower body,
b. the weight mounts below the lower body between the lower members,
c. the left lower member and the right lower member are lower members that extend from the bottom of lower body,
d. the lower members provide a mounting location for the weight,
e. a platform extends in a perpendicular direction from the side of lower body,
f. the platform extends out past the bottom of the hollow tube, and
g. the pin affixes the weight to the lower members.

9. The castable depth finding device described in claim 8 wherein
a. the hollow tube extends downward from the upper body,
b. the upper end of hollow tube is hydraulically connected to upper cavity,
c. the lower end of hollow tube is open to surrounding environment,
d. the arch is adjacent to the lower body and upper body, and
e. the arch forms a fishing line hole in the arch.

10. The castable depth finding device described in claim 9 wherein the fishing line hole allows the castable depth finding device to be cast or lowered into the water and retrieved via a fishing line.

11. The castable depth finding device described in claim 10 wherein
a. the body neck is hollow in the inside with an opening at the top,
b. the bottom portion of the body neck is hydraulically connected to upper cavity, and
c. the water emptying port threadedly connects to the body neck,

12. The castable depth finding device described in claim 11 wherein the water emptying port comprises a water emptying means that is opened to empty the contents of the Castable Depth Finding Device.

13. The castable depth finding device described in claim 12 wherein
a. the calibrated scale is located on the outside lower body,
b. the weight mounts below lower body between the lower members,
c. the left lower member and the right lower member are lower members that extend from the bottom of lower body,
d. the lower members provide a mounting location for the weight,
e. a platform extends in a perpendicular direction from the side of lower body,
f. the platform extends out past the bottom of the hollow tube, and
g. the pin affixes the weight to the lower members.

14. The castable depth finding device described in claim 13 wherein the water emptying means is a flip-top cap, a screw top, a tulip-style dispensing cap, or a disk style dispensing cap.
